(19) United States
(12) Patent Application Publication
(10) Pub. No.: US 2017/0082979 A1
(43) Pub. Date: Mar. 23, 2017

(54) Electronic Timepiece for Identifying Time by Colored Light

(71) Applicant: Steven Smith, Godfrey, IL (US)

(72) Inventor: Steven Smith, Godfrey, IL (US)

(21) Appl. No.: 15/267,847

(22) Filed: Sep. 16, 2016

Related U.S. Application Data
(60) Provisional application No. 62/220,457, filed on Sep. 18, 2015.

(51) Int. Cl. G04G 9/00

(52) U.S. Cl. CPC G04G 9/00

(57) ABSTRACT

An electronic timepiece for identifying time by colored light. The electronic timepiece is configured to identify time utilizing colored light corresponding to predetermined digits, rather than identifying time in digital or analog fashion. The electronic timepiece includes a lighting assembly having light sources that correspond to the hour of day, the minute of day, and the seconds of day. Each light source is coupled to a microcontroller that generates the time of day. The light sources are configured to emit a certain color of light based on the time of day communicated by the microcontroller. The emitted color represents a specific digit, such that a user can determine the time of day based on the combination of colors displayed by the lighting assembly.

This application claims the benefit of U.S. Provisional Application No. 62/220,457 filed on Sep. 18, 2015. The above identified patent application is herein incorporated by reference in its entirety to provide continuity of disclosure.

### BACKGROUND OF THE INVENTION

The present invention relates to timepieces. More specifically, the present invention relates to an electronic timepiece that identifies time based on colored light, whereby each individual color corresponds to a certain digit.

Traditional timepieces, such as analog or digital clocks, employ dials including hour, minute, and second hands and/or numerical indicia for indicating the time of day. Though, these timepieces are traditional and essentially the standards for indicating time, they are old concepts having little innovative value. Therefore, there is a need in the art for a new concept timepiece that indicates the time of day without the assistance of numerals and/or dials.

### SUMMARY OF THE INVENTION

In view of the foregoing disadvantages inherent in the known types of timepieces now present in the prior art, the present invention provides an electronic timepiece for identifying time by colored light, wherein the same can be utilized for providing convenience for the user when telling time. The electronic timepiece comprises a lighting assembly including a first light source, a second light source, a third light source, and a fourth light source. The first light source, the second light source, the third light source, and the fourth light source are each configured to emit at least a first color, a second color, a third color, a fourth color, a fifth color, a sixth color, a seventh color, an eighth color, a ninth color, and a tenth color. The first color, second color, third color, fourth color, fifth color, sixth color, seventh color, eighth color, ninth color, and tenth color each correspond to a digit. The first light source is configured to correspond to a tens place value of an hour. The second light source is configured to correspond to a singles place value of an hour. The third light source is configured to correspond to a tens place value of a minute. The fourth light source is configured to correspond to a singles place value of a minute.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the electronic timepiece powered off.

FIG. 1B shows a perspective view of the electronic time piece powered on.

FIG. 2 shows a block diagram of the electronic timepiece.

FIG. 3 shows a key for determining the time based on the colors of light emitted by the light sources according to one embodiment of the electronic timepiece.

### DETAILED DESCRIPTION OF THE INVENTION

Reference is made herein to the attached drawings. Like reference numerals are used throughout the drawings to depict like or similar elements of the electronic timepiece. The figures are intended for representative purposes only and should not be considered to be limiting in any respect.

As used herein, “logic” refers to (i) logic implemented as computer instructions and/or data within one or more computer processes and/or (i) logic implemented in electronic circuitry. In the interests of economy, the present disclosure refers to “a processor,” and so on. However, this should not be read as limiting in any way as the present disclosure contemplates embodiments of the present invention utilizing “one or more processors,” and so on. Unless specifically limited to a single unit, “a” is intended to be equivalent to “one or more” throughout the present disclosure.

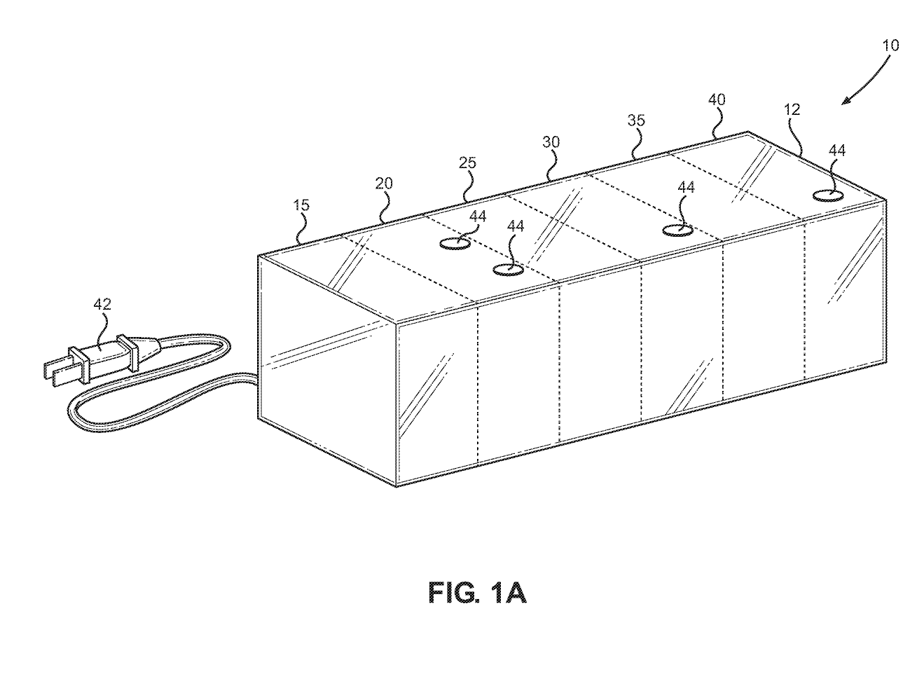

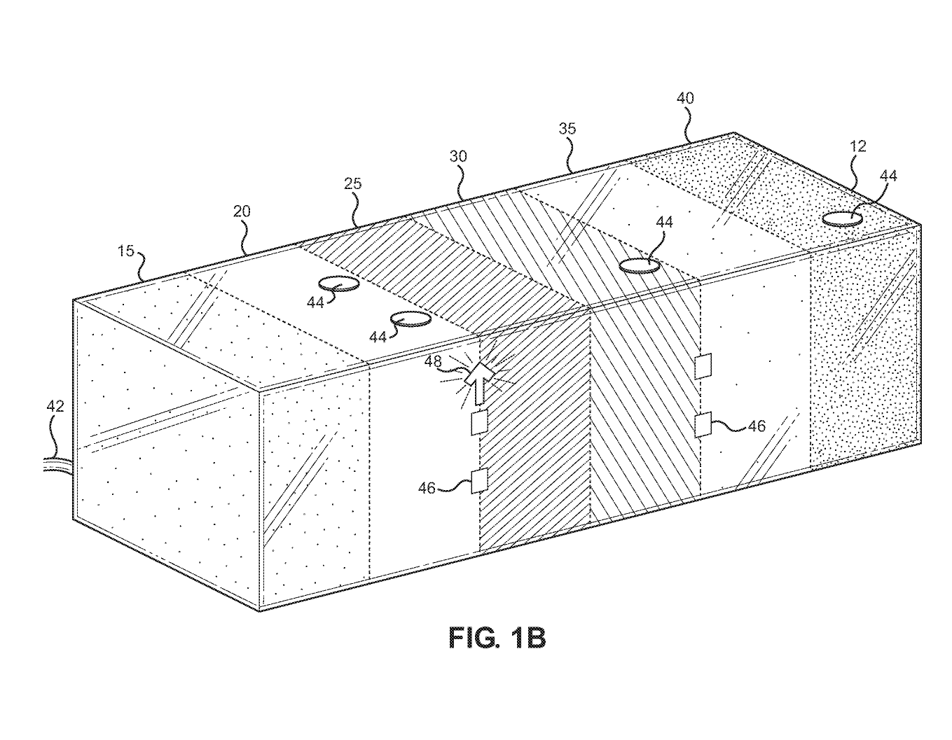

Referring now to FIGS. 1A and 1B, there are shown perspective views of the electronic timepiece powered off and on, respectively. The electronic timepiece is configured to indicate the time of day utilizing colored lights, which correspond to predetermined digits, rather than identifying time in digital or analog fashion. The electronic timepiece comprises a lighting assembly 10, which includes light sources that in combination correspond to the hours, minutes, and seconds of the time of day. In one embodiment, each light source corresponds to a place value of each of the hour, minute, and second of the day. The lighting assembly 10 is coupled to a computer, e.g., a microcontroller, that is configured to track and output the time of day. The light sources are configured to emit multiple different colors, wherein each emitted color represents a specific digit. Thus, a user can determine the time of day based on the combination of colors displayed by the lighting assembly 10.

The lighting assembly 10 comprises a translucent housing 12 including a first light source 15, a second light source 20, a third light source 25, a fourth light source 30, a fifth light source 35, and a sixth light source 40. In an illustrative embodiment, the housing 12 is rectangular; however, no restriction on the size or shape of the housing 12 is intended. The lights sources 15, 20, 25, 30, 35, 40 are linearly disposed within the housing and positioned adjacent to one another such that they form a sequential linear arrangement. The light sources 15, 20, 25, 30, 35, 40 are arranged according to the international standard notation for time of day, or hh:mm:ss, where hh is the number of complete hours that have passed since midnight (00-24 or 0-12), mm is the number of complete minutes that have passed since the start of the hour (00-59), and ss is the number of complete seconds since the start of the minute (00-60).

The first and second light sources 15, 20 correspond to the hour value, or hh, wherein the first light source 15 corresponds to the tens place value of an hour and the second light source 20 corresponds to the singles place value of an hour. The third and fourth light sources 25, 30 correspond to the minute value, or mm, wherein the third light source corresponds to the tens place value of a minute and the fourth light source 30 corresponds to the singles place value of a minute. The fifth and sixth light sources 35, 40 correspond to the second value, or ss, wherein the fifth light source 35 corresponds to the tens place value of a second and the sixth light source 40 corresponds to the singles place value of a second. In one embodiment, the lighting assembly 10 includes only a first light source, a second light source, a third light source, and a fourth light source, which correspond to the tens place value of an hour, the singles place value of an hour, the tens place value of a minute, and the singles place value of a minute, respectively.

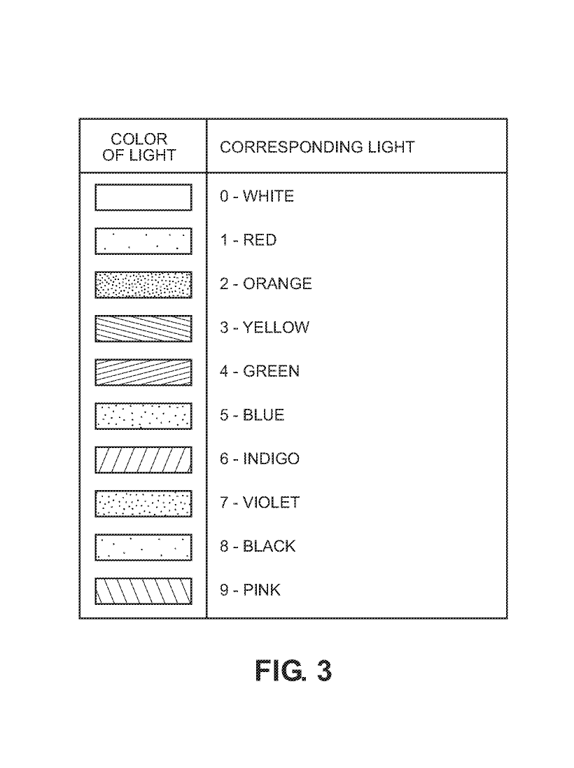

Each of the light sources of the lighting assembly 10 are configured to emit at least ten distinct colors of light. Each color of light corresponds to a certain digit ranging from 0-9, as represented by the diagram in FIG. 3. Assigning each digit to a single color of light allows the lighting assembly 10 to indicate the time of day via the combination of different colors emitted by each of the light sources, without actually displaying the time in a digital or analog fashion.

The lighting assembly 10 further includes a power supply 42 operably coupled to the lighting assembly 10. In the depicted embodiment, the power supply 42 is a power cord configured to plug into a power outlet. In alternative embodiments, the power supply 42 may include a battery, such as a rechargeable or disposable battery, such that the timepiece does not have to be plugged into a power outlet at all times to operate. The translucent housing 12 includes one or more inputs 44 for adjusting the time generated by the microcontroller. In the depicted embodiment, the one or more inputs 44 include an hour value button for adjusting the hour value, a minute value button for adjusting the minute value, a second value button for adjusting the second value, and a set time button for putting the timepiece into a set time mode, thereby enabling an individual to correct or change the time by adjusting the one or more inputs 44, such as the hour and minute value buttons.

The lighting assembly 10 further includes a pair of flashing light sources 46 for providing a visual cue separating the hour, minute, and second time values. The flashing light sources 46 include a first flashing light source positioned between the second light source 15 and third light source 25 and a second flashing light source positioned between the fourth light source 30 and the fifth light source 35. In the depicted embodiment, the pair of flashing light sources 46 are arranged in the shape of colons. In one embodiment, the lighting assembly comprises one flashing light source positioned between the second light source 15 and the third light source 25.

The lighting assembly 10 further includes an AM/PM indicating light source 48 that is configured to illuminate differently depending on whether the displayed time is in the AM or the PM. In the depicted embodiment, the AM/PM indicating light source 48 is a flashing arrow positioned in between the second light source 20 and third light source 25, which flashes upwards to indicate the time as being AM and flashes downwards to indicate the time as being PM. In another embodiment, the AM/PM indicating light source includes AM and PM indicia that light up according to the time of day.

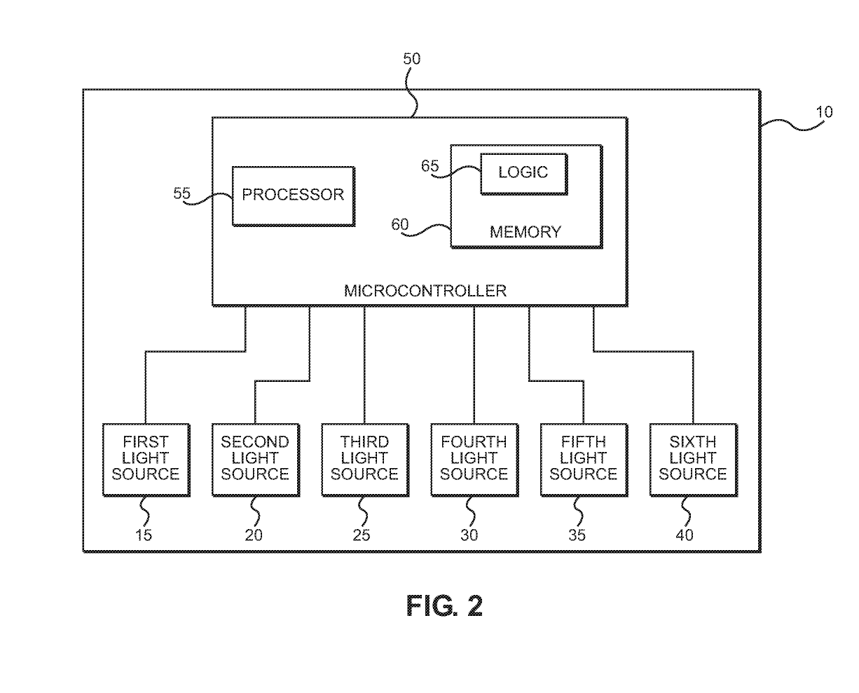

Referring now to FIG. 2, there is shown a block diagram of the electronic timepiece. The microcontroller 50 of the lighting assembly 10 includes a processor 55, a memory 60, and a logic 65. The memory 60 is in operative communication with the processor 55 and the logic 65 is stored on the memory 60 and executed by the processor 55. The microcontroller 50 is in communication with each of the first light source 15, the second light source 20, the third light source 25, the fourth light source 30, the fifth light source 35, and the sixth light source 40. The microcontroller 50 is configured to generate time in the international standard notation format or hh:mm:ss. The memory 60 stores information that denotes the color corresponding to each digit.

When executed by the processor 55, the logic 65 is configured to retrieve the time of day. For example, in one embodiment, the logic 65 comprises a timer circuit configured to keep time. The logic 65 retrieves from the memory 60 the color corresponding to the digit of the tens place of the hour of the time and turns the first light source 15 to that color, retrieves from the memory 60 the color corresponding to the digit of the singles place of the hour of the time and turns the second light source 20 to that color, retrieves from the memory 60 the color corresponding to the digit of the tens place of the minute of the time and turns the third light source 25 to that color, and so on for each successive light source.

Referring now to FIG. 3, there is shown a diagram of an array of the colors associated with the digits in the memory. In the depicted embodiment, the array includes digits 0-9, wherein each digit corresponds to a different color.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An electronic timepiece, comprising:
a lighting assembly including a first light source, a second light source, a third light source, and a fourth light source;
the first light source, the second light source, the third light source, and the fourth light source each configured to emit at least a first color, a second color, a third color, a fourth color, a fifth color, a sixth color, a seventh color, an eighth color, a ninth color, and a tenth color;
wherein the first color, second color, third color, fourth color, fifth color, sixth color, seventh color, eighth color, ninth color, and tenth color each correspond to a digit;
wherein the first light source is configured to correspond to a tens place value of an hour;
wherein the second light source is configured to correspond to a singles place value of an hour;
wherein the third light source is configured to correspond to a tens place value of a minute;
wherein the fourth light source is configured to correspond to a singles place value of a minute.

2. The electronic timepiece of claim 1, further comprising a microcontroller configured to generate a time, the microcontroller being in communication with each of the first light source, the second light source, the third light source, and the fourth light source.

3. The electronic timepiece of claim 2, wherein the microcontroller, comprises:
a processor;
a memory in operative communication with the processor;
a logic disposed on the memory, that when executed by the processor, causes the electronic timepiece to perform a method, the method comprising:
retrieving a time from a timer circuit;
retrieving from the memory a color corresponding to a digit of a tens place of an hour value of the time;
turning the first light source to the color retrieved;
retrieving from the memory a color corresponding to a digit of a singles place of an hour value of the time;
turning the second light source to the color retrieved;
retrieving from the memory a color corresponding to a digit of a tens place of a minute value of the time;
turning the third light source to the color retrieved;
retrieving from the memory a color corresponding to a digit of a singles place of a minute value of the time;
turning the fourth light source to the color retrieved.

4. The electronic timepiece of claim 1, wherein the lighting assembly comprises a translucent housing including the first light source, the second light source, the third light source, and the fourth light source, wherein the light sources are operably coupled to a power supply.

5. The electronic timepiece of claim 4, wherein the first light source, the second light source, the third light source, and the fourth light source are positioned adjacent to one another forming a linear arrangement.

6. The electronic timepiece of claim 2, wherein the lighting assembly further comprises one or more inputs configured to adjust the time generated by the microcontroller.

7. The electronic timepiece of claim 1, further comprising an am/pm indicating light source.

8. The electronic timepiece of claim 1, further comprising a flashing light source positioned in between the second light source and third light source.

9. An electronic timepiece, comprising:
a lighting assembly including a first light source, a second light source, a third light source, a fourth light source, a fifth light source, and a sixth light source;
the first light source, the second light source, the third light source, the fourth light source, the fifth light source, and the sixth light source each configured to emit at least a first color, a second color, a third color, a fourth color, a fifth color, a sixth color, a seventh color, an eighth color, a ninth color, and a tenth color;
wherein the first color, second color, third color, fourth color, fifth color, sixth color, seventh color, eighth color, ninth color, and tenth color each correspond to a digit;
wherein the first light source is configured to correspond to a tens place value of an hour;
wherein the second light source is configured to correspond to a singles place value of an hour;
wherein the third light source is configured to correspond to a tens place value of a minute;
wherein the fourth light source is configured to correspond to a singles place value of a minute;
wherein the fifth light source is configured to correspond to a tens place value of a second;
wherein the sixth light source is configured to correspond to a singles place value of a second.

10. The electronic timepiece of claim 9, further comprising a microcontroller configured to generate a time, the microcontroller being in communication with each of the first light source, the second light source, the third light source, the fourth light source, the fifth light source, and the sixth light source.

11. The electronic timepiece of claim 10, wherein the microcontroller, comprises:
a processor;
a memory in operative communication with the processor;
a logic disposed on the memory, that when executed by the processor, causes the electronic timepiece to perform a method, the method comprising:
retrieving a time from a timer circuit;
retrieving from the memory a color corresponding to a digit of a tens place of an hour value of the time;
turning the first light source to the color retrieved;
retrieving from the memory a color corresponding to a digit of a singles place of an hour value of the time;
turning the second light source to the color retrieved;
retrieving from the memory a color corresponding to a digit of a tens place of a minute value of the time;
turning the third light source to the color retrieved;
retrieving from the memory a color corresponding to a digit of a singles place of a minute value of the time;
turning the fourth light source to the color retrieved;
retrieving from the memory a color corresponding to a digit of the tens place of a seconds value of the time;
turning the fifth light source to the color retrieved;
retrieving from the memory a color corresponding to a digit of the singles place of a seconds value of the time;
turning the sixth light source to the color retrieved.

12. The electronic timepiece of claim 9, wherein the lighting assembly comprises a translucent housing including the first light source, the second light source, the third light source, the fourth light source, the fifth light source, and the sixth light source wherein the light sources are operably coupled to a power supply.

13. The electronic timepiece of claim 12, wherein the first light source, the second light source, the third light source, the fourth light source, the fifth light source, and the sixth light source are positioned adjacent to one another forming a linear arrangement.

14. The electronic timepiece of claim 10, wherein the lighting assembly further comprises one or more inputs configured to adjust the time generated by the microcontroller.

15. The electronic timepiece of claim 9, further comprising an am/pm indicating light source.

16. The electronic timepiece of claim 9, further comprising a pair of flashing light sources, wherein a first flashing light source is positioned in between the second light source and the third light source and a second flashing light source is positioned in between the fourth light source and the fifth light source.
